(19) United States
(12) Patent Application Publication
(10) Pub. No.: US 2010/0148904 A1
(43) Pub. Date: Jun. 17, 2010

(54) COIL ASSEMBLY

(75) Inventors: K.K. Xie, Dong-Guan City (CN); Alius Xiong, Dong-Guan City (CN)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: DELTA ELECTRONICS, INC., Taoyuan Hsien (TW)

(21) Appl. No.: 12/464,458

(22) Filed: May 12, 2009

(30) Foreign Application Priority Data
Dec. 16, 2008 (TW) 097222543

(51) Int. Cl. H01F 27/02; H01F 27/30

(52) U.S. Cl. 336/90; 336/199

(57) ABSTRACT

A coil assembly is disclosed. The coil assembly comprises a flexible core, a wire assembly and a joint assembly. The inductance of the coil assembly is adjustable by changing the length and the number of the loop of the first and the second wire. As a result, the fixed conventional supporting core that cannot be applied to various usages is improved, and can thereby be more flexible and applied to other usages.

This application claims the benefit from the priority of Taiwan Patent Application No. 097222543 filed on Dec. 16, 2008, and the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention provides an electromagnetic induction component, in particular, a coil assembly for an electromagnetic product.

2. Descriptions of the Related Art

Electrical appliances that are commonly used in daily lives mostly comprise therein a variety of parts that operate under the electromagnetic induction principle, among which coils are undoubtedly the most common part. Conventional coils have a support rack of a fixed shape (most of which are iron cores) therein for copper wires to be wound thereon to form a coil. This arrangement mainly has the following disadvantages: (1) the support rack of the fixed shape can only be used for products of particular specifications, and in case the product specifications are subject to change, the support rack has to be resized accordingly to comply with the changed specifications, so it has poor flexibility; and (2) when the product must comply with the insulation and fixation requirements completely, this can only be accomplished by filling gels and baking, which represents a complex process and delivers poor production efficiency and yield.

Accordingly, efforts still have to be made in this industry to provide a coil assembly that is adaptable for different usages and effectively lower production costs.

### SUMMARY OF THE INVENTION

The objective of the present invention is to provide a coil assembly, which comprises a flexible core, a wire assembly and a joint assembly. The flexible core has two opposite ends. The wire assembly is wound around an outer surface of the flexible core and comprises a first wire layer and a second wire layer. The joint assembly is configured to join two opposite ends of the flexible core so that the flexible core is formed as a closed loop. The coil assembly further comprises a thermal shrinkable sleeve disposed outside for insulating and fixing the coil.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the structure of a coil assembly of the present invention;

FIG. 2 is a schematic view illustrating step 1 in the process of manufacturing the coil assembly of the present invention;

FIG. 3 is a schematic view illustrating step 2 in the process of manufacturing the coil assembly of the present invention;

FIG. 4 is a schematic view illustrating step 3 in the process of manufacturing the coil assembly of the present invention; and

FIG. 5 is a cross-sectional view taken along line A-A in FIG. 4.

### DESCRIPTION OF THE PREFERRED EMBODIMENT

In the following description, this invention will be explained with reference to embodiments thereof. However, these embodiments are not intended to limit this invention to any specific environment, applications or particular implementations described in these embodiments. Therefore, description of these embodiments is only for purposes of illustration rather than limitation. It should be appreciated that in the following embodiments and the attached drawings, elements unrelated to this invention are omitted from depiction; and dimensional relationships among individual elements in the attached drawings are illustrated only for ease of understanding, but not to limit the actual scale.

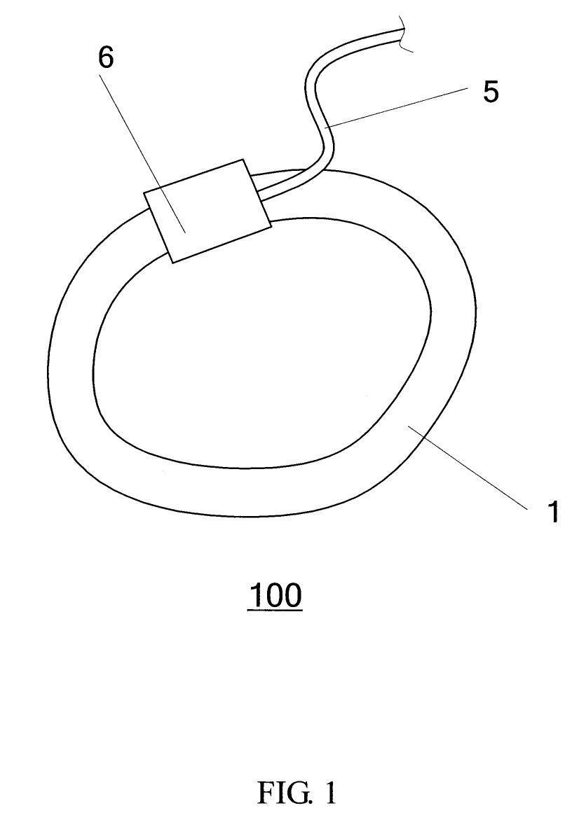

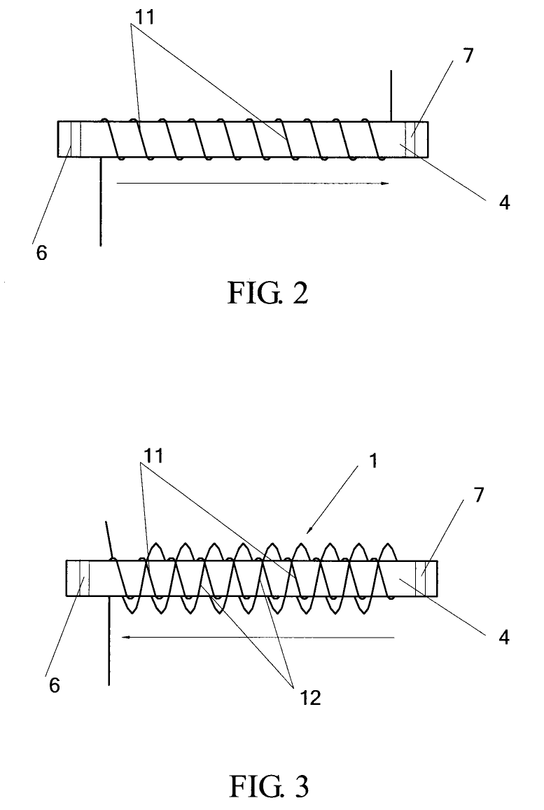

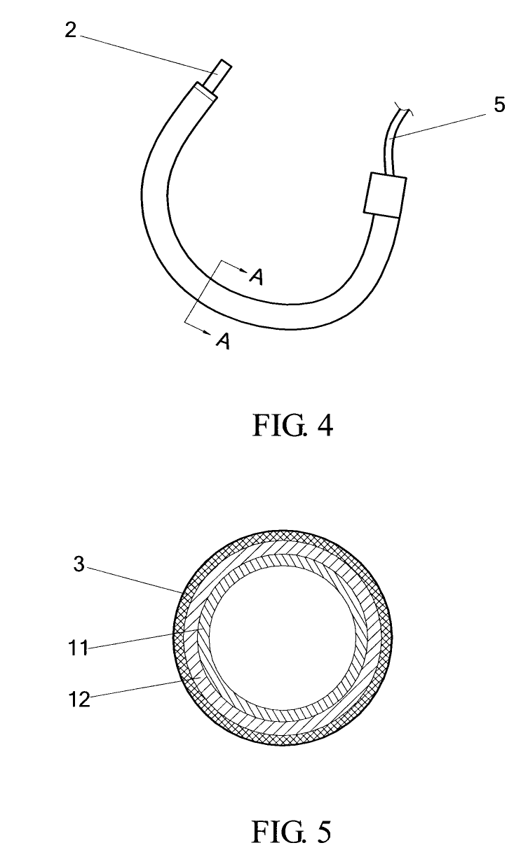

In reference to FIGS. 1 through 5, the coil assembly 100 of this embodiment comprises a wire assembly 1, a joint assembly 2, a sleeve 3 and a flexible core 4. The wire assembly 1 is formed by winding the first wire layer 11 and second wire layer 12 onto the outer surface of the flexible core 4 and is then wrapped around by the sleeve 3 (e.g., a thermal shrinkable sleeve) on the outer surface. Unlike the prior art, the flexible core 4 of this embodiment is a linear and flexible hollow cylinder with two opposite ends. The length of the flexible core 4 may be determined depending on the dimensional specifications of the coil; for example, the length of the flexible core 4 in this embodiment ranges between 70 mm and 100 mm, although it is not limited thereto. Additionally, the flexible core 4 is made of a material comprising silicone to facilitate the subsequent process of bending the flexible core 4 into an annular shape to form an annular coil. Because the flexible core 4 can be varied in length depending on the specifications of the annular coil, the disadvantage of the fixed conventional support racks is prevented, thereby remarkably increasing the flexibility in production and reducing both the number of manufacturing processes and costs necessary for producing moulds of various dimensions.

Additionally, the first wire layer 11 and the second wire layer 12 of the wire assembly 1 are wound on the outer surface of the flexible core 4 along opposite directions and are overlapping each other, with the second wire layer 12 wound on the outer surface of the first wire layer 11. Both the first wire layer 11 and second wire layer 12 are metal wires comprising about 400 coils around the flexible core 4, although it is not limited thereto. The wire assembly 1 should be made of a copper wire of size 34 AWG (American wire gauge).

Furthermore, the joint assembly 2 of the present invention is adapted to join the two opposite ends of the flexible core 4 together so that the flexible core 4 is formed as a closed loop. It should be noted that the joint assembly can be varied appropriately according to different configurations of the flexible core. As an example, if the flexible core is a solid column, the joint assembly is comprised of a protruding joint and a ring disposed at the two opposite ends of the flexible core respectively, with the protruding joint inserted into the ring. In contrast, in this embodiment where the flexible core 4 is a hollow column, the joint assembly 2 comprises a protruding joint, which is disposed at one of the two opposite ends of the flexible core 4 and adapted to be inserted into the hollow column so that the flexible core 4 is formed as a closed loop.

Hereinbelow, the manufacturing process of the annular coil assembly of the present invention will be detailed with reference to an embodiment thereof.

Step 1: A flexible core 4, which is a silicone tube in this embodiment, has a length of about 86 mm. From the left side where the left adhesive tape 6 is wound, a 34 AWG copper wire is wound 400 +1/−0 turns towards the right side to form a first wire layer 11 and then fixed by a right adhesive tape 7. Here, the silicone tube is used to replace conventional iron support racks, and allows for tailoring the inductance to specific applications through the adjustment in length and the turn number of the silicone tube.

Step 2: From the right adhesive tape 7, a 34 AWG copper wire is wound 400 +1/−0 turns towards the left side to form a second wire layer 12. Then, one or two additional turns are wound at the end of the coil and fixed by an adhesive tape to ensure a safety distance.

Step 3: The sleeve 3 is inserted over the outer surface of the wire assembly 1. The sleeve 3 is a thermal shrinkable sleeve, so that after being heated, it is shrunken to insulate the coil from the surroundings.

Step 4: The joint assembly 2 comprising a protruding joint is inserted into one of the two opposite ends of the flexible core 4 and connected to a conductor 5 from the two lead-out terminals of each of the first and the second wire layers 11, 12 to the outside.

Step 5: The two opposite ends of the flexible core 4 are joined together by means of the joint assembly 2 to form a closed loop coil.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A coil assembly, comprising:
a flexible core, having two opposite ends;
a wire assembly wound around an outer surface of the flexible core; and
a joint assembly, being configured to joint two opposite ends of the flexible core so that the flexible core is formed as a closed loop.

2. The coil assembly of claim 1, wherein the flexible core comprises a silicone material.

3. The coil assembly of claim 1, wherein a length of the flexible core is between 70˜100 millimeters.

4. The coil assembly of claim 1, wherein the wire assembly comprises a first wire layer and a second wire layer, and the first wire layer is wound around the outer surface of the flexible core with the second wire layer overlapped thereon and wound in a reverse direction.

5. The coil assembly of claim 4, wherein the first wire layer is a metal wire comprising about 400 coils around the flexible core.

6. The coil assembly of claim 4, wherein the second wire layer is a metal wire comprising about 400 coils around the flexible core.

7. The coil assembly of claim 4, further comprising two leads connecting the first wire layer and the second wire layer respectively.

8. The coil assembly of claim 1, wherein when the flexible core is a solid column, the joint assembly comprises a protruding joint and a ring disposed on the opposite ends of the flexible core respectively, and the protruding joint is adapted to be inserted into the ring.

9. The coil assembly of claim 1, wherein when the flexible core is a hollow cylinder, the joint assembly comprises a protruding joint disposed on one of the opposite ends of the flexible core, and the protruding joint is adapted to be inserted into the hollow cylinder.

10. The coil assembly of claim 1, further comprising a sleeve, wherein the sleeve wrapped around an outer surface of the wire assembly.

11. The coil assembly of claim 10, wherein the sleeve is a thermal contractible tube.
